(19) United States
(12) Patent Application Publication
(10) Pub. No.: US 2024/0184183 A1
(43) Pub. Date: Jun. 6, 2024

(54) IMAGING DEVICE AND IMAGING SYSTEM

(71) Applicant: SONY SEMICONDUCTOR SOLUTIONS CORPORATION, KANAGAWA (JP)

(72) Inventor: MAKOTO CHIYODA, KANAGAWA (JP)

(21) Appl. No.: 18/549,360

(22) PCT Filed: Feb. 1, 2022
(86) PCT No.: PCT/JP2022/003764

§ 371 Date: Sep. 7, 2023

(30) Foreign Application Priority Data
Mar. 15, 2021 (JP) 2021-041552

(51) Int. Cl. G03B 7/095; G01S 17/894; G02F 1/133; H04N 23/56; H04N 23/75

(52) U.S. Cl. CPC G03B 7/095; G01S 17/894; G02F 1/13312; H04N 23/56; H04N 23/75; G02F 2203/11

(57) ABSTRACT

Provided is an imaging device capable of reducing a difference in resolution caused by a distance to a subject. An imaging device according to an embodiment of the present disclosure includes: an imaging section that photoelectrically converts reflection light reflected by a subject; and a liquid crystal optical aperture that is arranged on a side closer to the subject than the imaging section and has an aperture value that is variable depending on a distance to the subject and indicates a transmission light amount of the reflection light.

### TECHNICAL FIELD

The present disclosure relates to an imaging device and an imaging system.

### BACKGROUND ART

In a camera device that images a distance measurement image using a time of flight (ToF) method, a focal point is usually fixed regardless of a distance to a subject. Therefore, there is a case where it is difficult to secure the amount of light required to measure a contrast signal depending on the distance to the subject. In this case, a difference may occur in resolution of the distance measurement image due to the distance to the subject.

### CITATION LIST

### Patent Document

### Patent Document 1: Japanese Patent Application Laid-Open No. 2007-86221

### SUMMARY OF THE INVENTION

### Problems to be Solved by the Invention

The present disclosure provides an imaging device and an imaging system which are capable of reducing a difference in resolution caused by a distance to a subject.

### Solutions to Problems

An imaging device according to an embodiment of the present disclosure includes: an imaging section that photoelectrically converts reflection light reflected by a subject; and a liquid crystal optical aperture that is arranged on a side closer to the subject than the imaging section and has an aperture value that is variable depending on a distance to the subject and indicates a transmission light amount of the reflection light.

The imaging device may further include an emission optical system that irradiates the subject with infrared light.

In the imaging device, the aperture value may be variable on the basis of a contrast value of a distance measurement image generated on the basis of the photoelectric conversion of the imaging section.

In the imaging device, a light amount of the infrared light may be variable depending on a light amount of the reflection light incident on the liquid crystal optical aperture.

In the imaging device, exposure time of the imaging section may be variable depending on a light amount of the reflection light received by the imaging section.

In the imaging device, the aperture value may be variable on the basis of the distance measured in advance outside the imaging device.

In the imaging device, the aperture value may be variable on the basis of data optimized for every value of the distance.

The imaging device may further include a storage section that stores the data.

In the imaging device, a light-transmitting region and a light-shielding region may change depending on the aperture value of the liquid crystal optical aperture.

In the imaging device, the liquid crystal optical aperture may have a circular shape, and the light-transmitting region and the light-shielding region may change concentrically depending on the aperture value.

In the imaging device, the liquid crystal optical aperture may be circular, and the light-transmitting region and the light-shielding region may be changed in fan shapes depending on the aperture value.

In the imaging device, the liquid crystal optical aperture may have a rectangular shape, and the light-transmitting region and the light-shielding region may change in a side direction depending on the aperture value.

An imaging system according to an embodiment of the present disclosure includes: an imaging section that photoelectrically converts reflection light reflected by a subject; a liquid crystal optical aperture that is arranged on a side closer to the subject than the imaging section and has an aperture value that is variable depending on a distance to the subject and indicates a transmission light amount of the reflection light; an image signal processing section that processes a signal generated from the photoelectric conversion of the imaging section; and a control section that adjusts the aperture value on the basis of a processing result of the image signal processing section.

The imaging system may further include a switch that switches a connection destination of the control section between the image signal processing section and an external device that images the subject at the distance in advance.

In the imaging system, the aperture value may be variable on the basis of data optimized for every value of the distance.

In the imaging system, a light-transmitting region and a light-shielding region may change depending on the aperture value of the liquid crystal optical aperture.

In the imaging system, the liquid crystal optical aperture may have a circular shape, and the light-transmitting region and the light-shielding region may change concentrically depending on the aperture value.

In the imaging system, the liquid crystal optical aperture may have a circular shape, and the light-transmitting region and the light-shielding region may change in fan shapes depending on the aperture value.

In the imaging system, the liquid crystal optical aperture may have a rectangular shape, and the light-transmitting region and the light-shielding region may change in a side direction depending on the aperture value.

### BRIEF DESCRIPTION OF DRAWINGS

FIG. 1 is a diagram illustrating a configuration of an imaging device according to a first embodiment.

FIG. 2 is a diagram illustrating an example of a circuit configuration of an emission optical system.

FIG. 3 is a diagram illustrating another example of the circuit configuration of the emission optical system.

FIG. 4 is a diagram illustrating still another example of the circuit configuration of the emission optical system.

FIG. 5 is a cross-sectional view illustrating a schematic structure of a lens optical system.

FIG. 6 is a diagram illustrating an example of a circuit configuration of an imaging circuit.

FIG. 7 is a schematic diagram illustrating an example of a layout of the imaging circuit.

FIG. 8 is a block diagram illustrating another example of the imaging circuit.

FIG. 9 is a circuit diagram of a pixel arrayed in a pixel area.

FIG. 10 is a view illustrating an example of a configuration of a liquid crystal optical aperture.

FIG. 11 is a view illustrating optical characteristic graphs when an aperture pattern of the liquid crystal optical aperture has not changed.

FIG. 12 is a view illustrating optical characteristic graphs when the aperture pattern of the liquid crystal optical aperture has changed.

FIG. 13 is a view illustrating another example of the aperture pattern of the liquid crystal optical aperture.

FIG. 14 is a view illustrating still another example of the aperture pattern of the liquid crystal optical aperture.

FIG. 15 is a flowchart illustrating a procedure of an operation of adjusting an aperture value F of the liquid crystal optical aperture.

FIG. 16 is a flowchart illustrating another procedure of the operation of adjusting the aperture value F of the liquid crystal optical aperture.

FIG. 17 is a block diagram illustrating a configuration example of an imaging system according to a second embodiment.

FIG. 18 is a block diagram illustrating an example of a schematic configuration of a vehicle control system.

FIG. 19 is an explanatory diagram illustrating an example of installation positions of an outside-vehicle information detecting section and an imaging section.

### MODE FOR CARRYING OUT THE INVENTION

### First Embodiment

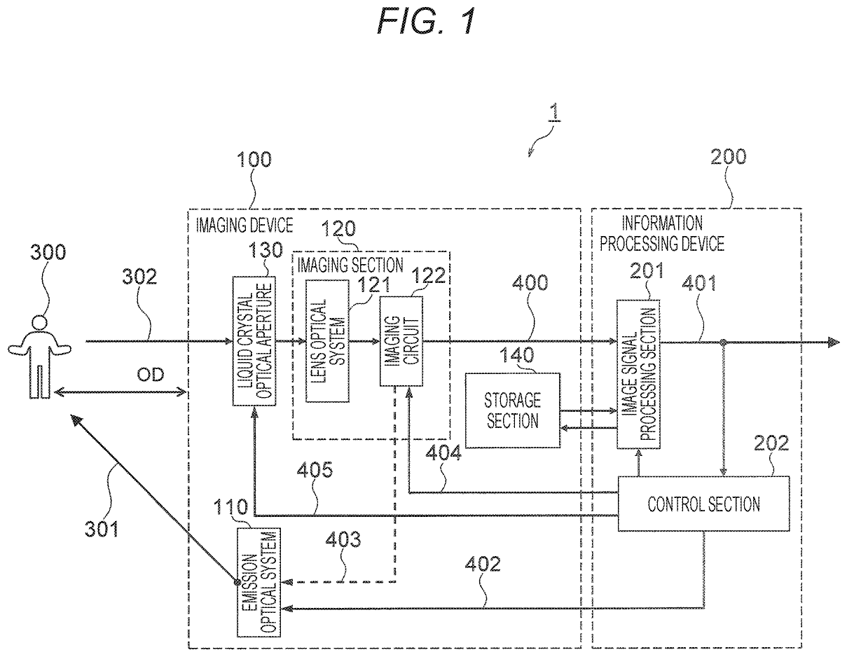

FIG. 1 is a block diagram illustrating a configuration example of an imaging system according to a first embodiment. An imaging system 1 illustrated in FIG. 1 is, for example, a camera device that images a distance measurement image using a time of flight (ToF) method, and includes an imaging device 100 and an information processing device 200.

The imaging device 100 includes an emission optical system 110, an imaging section 120, a liquid crystal optical aperture 130, and a storage section 140. The imaging section 120 includes a lens optical system 121 and an imaging circuit 122. In the imaging device 100, the emission optical system 110 irradiates a subject 300 with emission light 301. The emission light 301 is reflected by the subject 300. Reflection light 302 reflected by the subject 300 is transmitted through liquid crystal optical aperture 130 and incident on imaging section 120. In the imaging section 120, the imaging circuit 122 photoelectrically converts the reflection light 302 to generate a pixel signal 400. The pixel signal 400 is input to the information processing device 200.

The information processing device 200 includes an image signal processing section 201 and a control section 202. The image signal processing section 201 processes the pixel signal 400 to generate a distance measurement image. The distance measurement image includes information about a distance OD (Object Distance) from the imaging device 100 to the subject 300. The control section 202 controls the imaging device 100 on the basis of an image signal 401 output from the image signal processing section 201. The image signal 401 includes, for example, information regarding the distance measurement image, such as the distance OD, and a contrast value of the subject 300 with respect to a background.

Hereinafter, a configuration of the imaging device 100 will be described in detail.

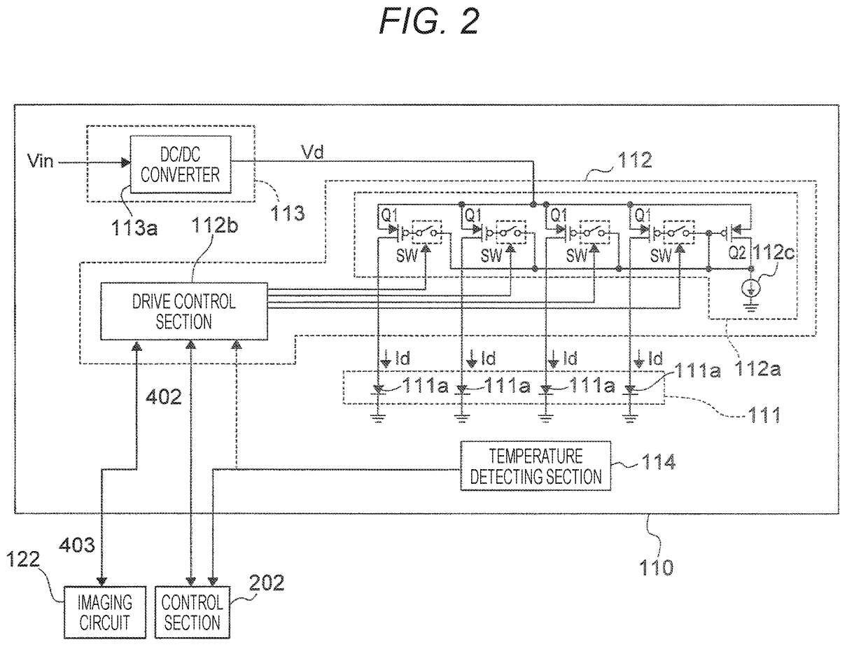

FIG. 2 is a diagram illustrating an example of a circuit configuration of the emission optical system 110. The emission optical system 110 illustrated in FIG. 2 includes a light emitting section 111, a drive section 112, a power supply section 113, and a temperature detecting section 114. The light emitting section 111, the drive section 112, and the power supply section 113 are formed on a common substrate (not illustrated). The temperature detecting section 114 detects the temperature of the substrate and outputs a detection value to the control section 202.

The light emitting section 111 includes a plurality of light emitting elements 111a connected in parallel to each other. Each of the light emitting elements 111a is an infrared laser diode. Note that the number of the light emitting elements 111a is only required to be at least two or more although FIG. 2 illustrates four light emitting elements 111a.

The power supply section 113 includes a DC/DC converter 113a. The DC/DC converter 113a generates a drive voltage Vd (DC voltage), used by the drive section 112 to drive the light emitting section 111, on the basis of an input voltage Vin that is a DC voltage.

The drive section 112 includes a drive circuit 112a and a drive control section 112b. The drive circuit 112a includes a plurality of switching elements Q1, a switching element Q2, a plurality of switches SW, and a constant current source 112c. The number of the switching elements Q1 and the number of the switches SW is the same as the number of the light emitting elements 111a. For example, a P-channel metal-oxide-semiconductor field-effect transistor (MOSFET) can be applied to the switching elements Q1 and the switching element Q2.

The respective switching elements Q1 are connected in parallel to an output line of the DC/DC converter 113a, that is, a supply line of the drive voltage Vd. On the other hand, the switching element Q2 is connected in parallel to the switching element Q1. In each of the switching elements Q1 and switching element Q2, a source is connected to the output line of the DC/DC converter 113a. A drain is connected to an anode of the corresponding light emitting element 111a among the plurality of light emitting elements 111a. A cathode of each of the light emitting elements 111a is grounded.

In the switching element Q2, a drain is grounded via the constant current source 112c, and a gate is connected to the drain and the constant current source 112c. A gate of each of the switching elements Q1 is connected to the gate of the switching element Q2 via each one corresponding switch SW.

When the switch SW is turned on in the drive circuit 112a, the switching element Q1 connected to the switch SW is turned on. Therefore, the drive voltage Vd is applied to the light emitting element 111a connected to the switching element Q1 that has been turned on so that the light emitting element 111a emits light. As a result, the subject 300 is irradiated with the emission light 301.

In the drive circuit 112a, the switching elements Q1 and the switching element Q2 constitute a current mirror circuit. Therefore, a current value of a drive current Id corresponds to a current value of the constant current source 112c. As the current value of the drive current Id increases, a light amount of the emission light 301 also increases.

The drive control section 112b controls turning on and off of the light emitting element 111a by controlling on and off of the switch SW. The drive control section 112b determines a timing to control turning on and off of the light emitting element 111a, a current value of the drive current Id, and the like on the basis of an instruction from the control section 202. For example, when a light emission control signal 402 including specified values of these as light emission parameters are received from the control section 202, the drive control section 112b controls driving of the light emitting element 111a according to the light emission control signal 402.

Furthermore, a light emission control signal 403 is input from the imaging circuit 122 to the drive control section 112b. The drive control section 112b synchronizes the timing for turning on and off the light emitting element 111a with a frame period of the imaging circuit 122 on the basis of the light emission control signal 403. Note that the drive control section 112b may transmit a frame synchronization signal or a signal indicating an exposure timing to the imaging circuit 122. Moreover, the control section 202 sometimes transmits the signals indicating frame synchronization and exposure timing to the drive control section 112b and the imaging circuit 122.

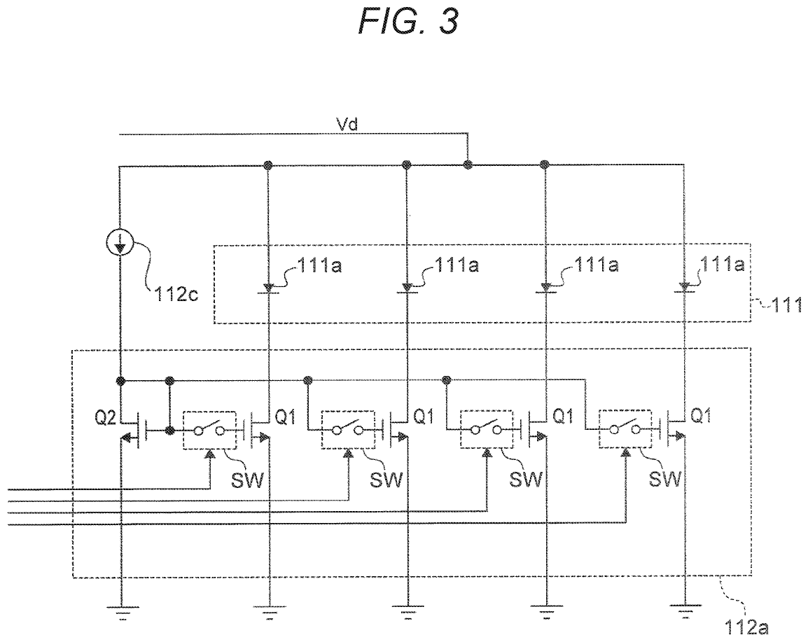

FIG. 3 is a diagram illustrating another example of the circuit configuration of the emission optical system 110. Components similar to those of components illustrated in FIG. 2 will be denoted by the same reference signs, and detailed description thereof will be omitted. FIG. 2 illustrates a circuit configuration in which the switching elements Q1 are connected to the anodes of the light emitting elements 111a. On the other hand, in the circuit illustrated in FIG. 3, the switching elements Q1 are connected to cathodes of the light emitting elements 111a. In this case, each of the light emitting elements 111a has an anode being connected to an output line of the DC/DC converter 113a. Furthermore, an N-channel MOSFET is used as the switching elements Q1 and the switching element Q2 constituting a current mirror circuit. In the switching element Q2, a drain and a gate are connected to the output line of the DC/DC converter 113a via the constant current source 112c, and a source is grounded via the constant current source 112c. In each of the switching elements Q1, a drain is connected to the cathode of the corresponding light emitting element 111a, and a source is grounded. A gate of each of the switching elements Q1 is connected to the gate and the drain of the switching element Q2 via each corresponding switch SW.

In a case where the emission optical system 110 has the circuit configuration illustrated in FIG. 3 as well, the drive control section 112b controls on and off of the switch SW. Therefore, the light emitting element 111a can be turned on and off.

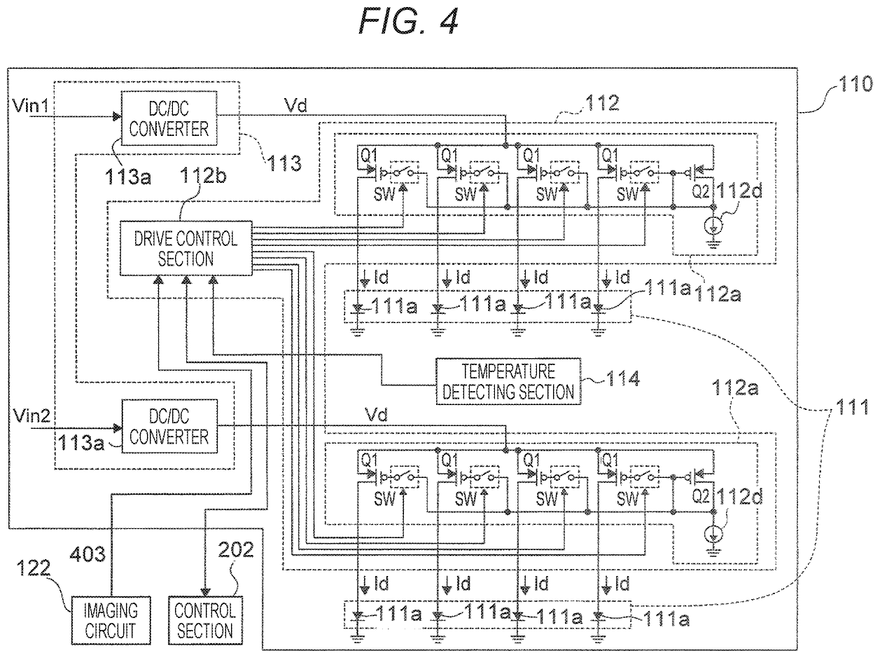

FIG. 4 is a diagram illustrating still another example of the circuit configuration of the emission optical system 110. In the emission optical system 110 illustrated in FIG. 4, the power supply section 113 includes two DC/DC converters 113a. An input voltage Vin1 is supplied to one of the DC/DC converters 113a. An input voltage Vin2 is supplied to the other DC/DC converter 113a.

Furthermore, the drive section 112 includes two drive circuits 112a in this emission optical system 110. The drive circuits 112a receive the drive voltages Vd from the mutually different DC/DC converters 113a, respectively. Moreover, each of the drive circuits 112a is provided with a variable current source 112d, instead of the constant current source 112c. The variable current source 112d is a current source whose current value is variable. In the case of this emission optical system 110, the plurality of light emitting elements 111a is divided into a plurality of light emitting element groups that are controlled by the mutually different drive circuits 112a. In this case, the drive control section 112b controls on and off of the switch SW in each of the drive circuits 112a.

As illustrated in FIG. 4, when a configuration is adopted in which at least combinations of the DC/DC converters 113a and the drive circuits 112a are divided into a plurality of systems, the drive current Id of the light emitting element 111a can be set to a different value for every system. For example, a value of the drive current Id can be made different for every system by making a voltage value of the drive voltage Vd and a current value of the variable current source 112d different for every system. Furthermore, if a configuration is adopted in which the DC/DC converter 113a performs constant current control regarding the drive current Id, the value of the drive current Id can be made different for every system by making a target value of the constant current control different between the DC/DC converters 113a.

In a case where the emission optical system 110 has the circuit configuration illustrated in FIG. 4, it is conceivable to make values of the drive voltage Vd and the drive current Id different for every system according to a light emission intensity distribution, a temperature distribution, and the like in the light emitting section 111. For example, it is conceivable to increase the drive current Id and increase the drive voltage Vd for a system corresponding to a site at a high temperature in the light emitting section 111.

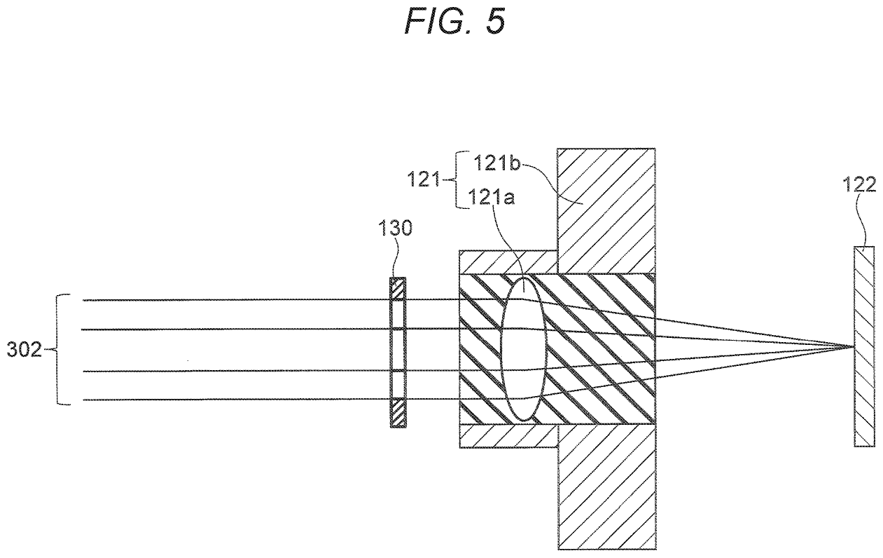

FIG. 5 is a cross-sectional view illustrating a schematic structure of the lens optical system 121. The lens optical system 121 includes a lens 121a and a lens barrel 121b. The lens 121a is accommodated in the lens barrel 121b so as to be located between the liquid crystal optical aperture 130 and the imaging circuit 122. The lens 121a forms an image of the reflected reflection light 302 transmitted through the liquid crystal optical aperture 130 on the imaging circuit 122. Note that the lens 121a can have any configuration, and for example, the lens 121a can be constituted by a plurality of lens groups.

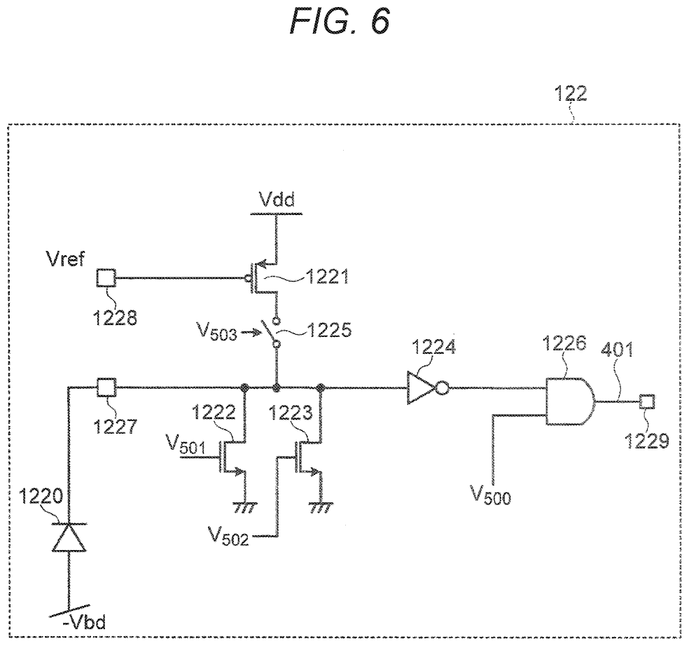

FIG. 6 is a diagram illustrating an example of a circuit configuration of the imaging circuit 122. The imaging circuit 122 illustrated in FIG. 6 includes a photodiode 1220, transistors 1221 to 1223, an inverter 1224, a switch 1225, and an AND circuit 1226.

The photodiode 1220 converts photons incident as the reflection light 302 into electric signals by photoelectric conversion, and outputs pulses depending on the incidence of the photons. The photodiode 1220 is formed with an avalanche photodiode such as a single photon avalanche diode (SPAD). The SPAD has a characteristic that electrons generated in response to incidence of one photon cause avalanche multiplication so that a large current flows when a large negative voltage that generates the avalanche multiplication is applied to a cathode. When this characteristic of the SPAD is used, the incidence of one photon can be detected with high sensitivity.

In the photodiode 1220, a cathode is connected to a terminal portion 1227, and an anode is connected to a voltage source of a voltage (−Vbd). The voltage (−Vbd) is a large negative voltage for generating avalanche multiplication in the SPAD. The terminal portion 1227 is connected to one end of the switch 1225 whose on and off are controlled according to a signal V₅₀₃. The other end of the switch 1225 is connected to a drain of the transistor 1221. The transistor 1221 is formed with a P-channel MOSFET. The transistor 1221 has a source being connected to a power supply voltage Vdd. Furthermore, the transistor 1221 has a gate connected to a terminal portion 1228 to which a reference voltage Vref is supplied.

The transistor 1221 is a current source that outputs a current from the drain according to the power supply voltage Vdd and the reference voltage Vref. With such a configuration, a reverse bias is applied to the photodiode 1220. When photons are incident on the photodiode 1220 in an on state of the switch 1225, the avalanche multiplication is started, and a current flows from the cathode to the anode of the photodiode 1220.

A signal extracted from a connection point between the drain of the transistor 1221 (one end of the switch 1225) and the cathode of the photodiode 1220 is input to the inverter 1224. The inverter 1224 performs, for example, a threshold determination on the input signal. Each time the input signal exceeds a threshold in a positive direction or a negative direction, the inverter 1224 outputs a pulsed signal Vpls.

The signal Vpls output from the inverter 1224 is input to a first input terminal of the AND circuit 1226. A signal V₅₀₀ is input to a second input terminal of the AND circuit 1226. In a case where both the signal Vpls and the signal V₅₀₀ are at a high level, the AND circuit 1226 outputs the pixel signal 400 from the imaging circuit 122 via a terminal portion 1229.

In the imaging circuit 122, the terminal portion 1227 is connected to a drain of each of the transistor 1222 and the transistor 1223. The transistor 1222 and the transistor 1223 are formed with N-channel MOSFETs. A source of each of the transistors is grounded, for example. A signal V₅₀₁ is input to a gate of the transistor 1222. Furthermore, a signal V₅₀₂ is input to a gate of the transistor 1223. In a case where at least one of the transistor 1222 or the transistor 1223 is in an off state, a cathode potential of the photodiode 1220 is forcibly set to a ground potential, and the signal Vpls is fixed to a low level.

In the present embodiment, the plurality of photodiodes 1220 is two-dimensionally arranged. The signal V₅₀₁ and the signal V₅₀₂ described above are used as control signals in the vertical direction and the horizontal direction, respectively, of each of the photodiodes 1220. Therefore, the on states and the off states of the respective photodiodes 1220 can be individually controlled. The on state of each of the photodiodes 1220 is a state in which the signal Vpls can be output, and the off state of each of the photodiodes 1220 is a state in which the output of the signal Vpls is not possible.

For example, it is assumed that, in a matrix of the photodiodes 1220, the signal V₅₀₂ for turning on the transistor 1223 is input to consecutive q columns, and the signal V₅₀₁ for turning on the transistor 1222 is input to consecutive p rows. Therefore, the output of each of the photodiodes 1220 can be enabled in a block shape of p rows×q columns. Furthermore, the pixel signal 400 is output from the imaging circuit 122 by a logical product of the signal Vpls and the signal V₅₀₀ in the AND circuit 1226. Therefore, for example, it is possible to control enabling and disabling in more detail for the output of each of the photodiodes 1220 enabled by the signal V₅₀₁ and the signal V₅₀₂.

Moreover, for example, when the signal V₅₀₃ for turning off the switch 1225 is supplied to the imaging circuit 122 including the photodiode 1220 whose output is disabled, the supply of the power supply voltage Vdd to this photodiode 1220 can be stopped, and the imaging circuit 122 can be turned off. Therefore, power consumption can be reduced.

The above-described signals V₅₀₀ to V₅₀₃ are generated by the control section 202 on the basis of, for example, a parameter stored in a register or the like included in the control section 202. The parameter may be stored in the register in advance, or may be stored in the register in accordance with an external input. The signals V₅₀₀ to V₅₀₃ generated by the control section 202 are input to each of the imaging circuits 122 as an exposure control signal 404 (see FIG. 1) for controlling the exposure time of the photodiode 1220.

Note that the control based on the signals V₅₀₁ to V₅₀₃ described above is control based on an analog voltage. On the other hand, the control based on the signal V₅₀₀ using the AND circuit 1226 is control based on a logic voltage. Therefore, the control based on the signal V₅₀₀ can be performed at a lower voltage than the control based on the signals V₅₀₁ to V₅₀₃, so that handling is easy.

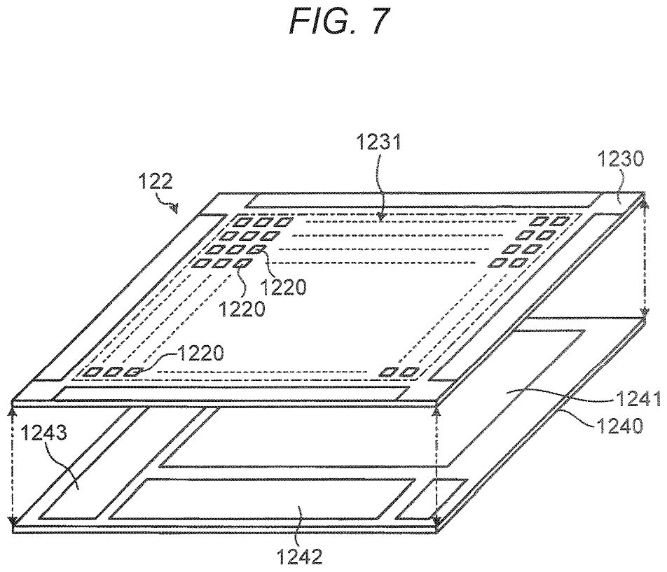

FIG. 7 is a schematic diagram illustrating an example of a layout of the imaging circuit 122. The imaging circuit 122 is dispersedly arranged in a light receiving chip 1230 and a logic chip 1240. The light receiving chip 1230 and the logic chip 1240 are semiconductor chips, and are stacked on each other.

The photodiodes 1220 are two-dimensionally arrayed in a pixel array section 1231 of the light receiving chip 1230. Furthermore, in the imaging circuit 122, the transistors 1221, 1102, and 1103, the switch 1225, the inverter 1224, and the AND circuit 1226 are formed on the logic chip 1240. The cathode of the photodiode 1220 is connected between the light receiving chip 1230 and the logic chip 1240 via the terminal portion 1227 using a copper-copper connection (CCC) or the like.

The logic chip 1240 is provided with a logic array section 1241 including a signal processing section that processes a signal acquired by the photodiode 1220. The logic chip 1240 can be further provided with a signal processing circuit section 1242 that processes the signal acquired by the photodiode 1220 and an element control section 1243 that controls an operation as the imaging device 100 in proximity to the logic array section 1241.

Note that configurations on the light receiving chip 1230 and the logic chip 1240 are not limited to this example. Furthermore, the element control section 1243 can be arranged, for example, in the vicinity of the photodiode 1220 for another purpose of driving or control other than the control of the logic array section 1241. The element control section 1243 can be provided to have any function in any region of the light receiving chip 1230 and the logic chip 1240 other than the arrangement illustrated in FIG. 7.

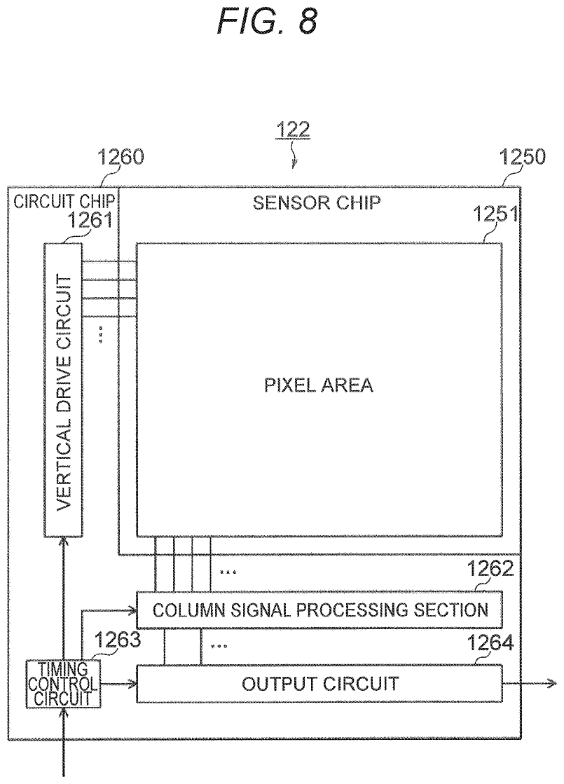

FIG. 8 is a block diagram illustrating another example of the imaging circuit 122. The imaging circuit 122 illustrated in FIG. 8 is an example of an indirect-time of flight sensor. The imaging circuit 122 is dispersedly arranged on a sensor chip 1250 and a circuit chip 1260 stacked on the sensor chip 1250.

The sensor chip 1250 has a pixel area 1251. The pixel area 1251 includes a plurality of pixels arranged two-dimensionally on the sensor chip 1250. Each of the pixels has a configuration capable of receiving the reflection light 302 and photoelectrically converting the reflection light into a pixel signal. The pixel area 1251 may be arranged on a matrix or may include a plurality of column signal lines. Each of the column signal lines is connected to the respective pixels.

In the pixel area 1251, the plurality of pixels is arranged in a two-dimensional grid pattern, and each of the pixels is configured to receive infrared light and photoelectrically convert the infrared light into a pixel signal.

In the circuit chip 1260, a vertical drive circuit 1261, a column signal processing section 1262, a timing control circuit 1263, and an output circuit 1264 are arranged.

The vertical drive circuit 1261 is configured to drive a pixel and output a pixel signal to the column signal processing section 1262. The column signal processing section 1262 performs analog-digital (AD) conversion processing on the pixel signal, and outputs the pixel signal subjected to the AD conversion processing to the output circuit 1264. The output circuit 1264 executes correlated double sampling (CDS) processing or the like on the signal from the column signal processing section 1262, and outputs the processed signal to the image signal processing section 201 of the information processing device 200 in the subsequent stage.

The timing control circuit 1263 is configured to control a drive timing of the vertical drive circuit 1261. The column signal processing section 1262 and the output circuit 1264 are synchronized with a vertical synchronization signal.

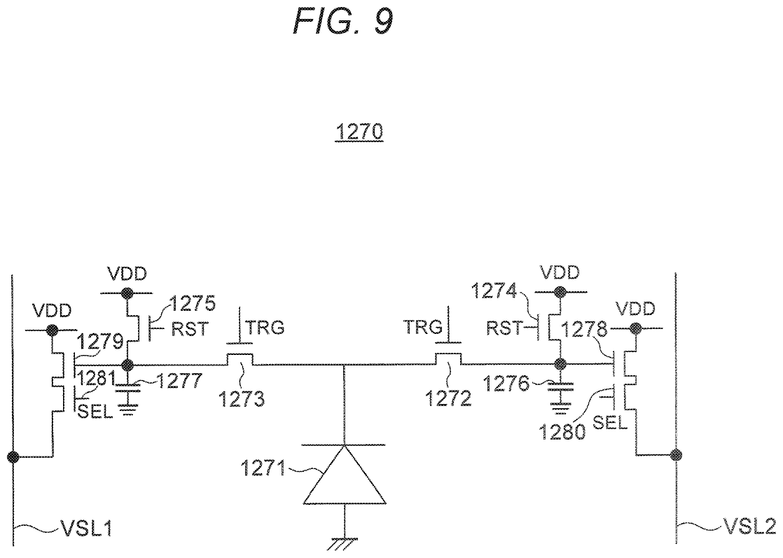

FIG. 9 is a circuit diagram of a pixel 1270 arrayed in the pixel area 1251. The pixel 1270 includes a photodiode 1271, two transfer transistors 1272 and 1273, two reset transistors 1274 and 1275, two floating diffusion layers 1276 and 1277, two amplification transistors 1278 and 1279, and two selection transistors 1280 and 1281.

The photodiode 1271 photoelectrically converts the reflection light 302 to generate charge. When a surface of the sensor chip 1250 on which a circuit is arranged is a front surface, the photodiode 1271 is arranged on a back surface with respect to the front surface. Such an imaging element is called a back-illuminated imaging element. Note that a front-illuminated configuration in which the photodiode 1271 is arranged on the front surface can also be used, instead of the back illuminated type.

The transfer transistors 1272 and 1273 sequentially transfer charge from the photodiode 1271 to each of the floating diffusion layer 1276 and the floating diffusion layer 1277 in accordance with a transfer signal TRG from the vertical drive circuit 1261. Each of the floating diffusion layers accumulates the transferred charge and generates a voltage corresponding to an amount of the accumulated charge.

The reset transistors 1274 and 1275 extract charge from the floating diffusion layer 1277 and the floating diffusion layer 1276, respectively, in accordance with a reset signal RST from the vertical drive circuit 1261 to initialize an amount of the charge. The amplification transistors 1278 and 1279 amplify voltages of the floating diffusion layer 1276 and the floating diffusion layer 1277, respectively. The selection transistors 1280 and 1281 output signals of the amplified voltages as pixel signals to the column signal processing section 1262 via two vertical signal lines (for example, VSL1, VSL2), respectively, in accordance with a selection signal SEL from the vertical drive circuit 1261. The VSL1 and VSL2 are connected to inputs of an AD converter (not illustrated) provided in the column signal processing section 1262.

Note that the circuit configuration of the pixel 1270 is not limited to the configuration illustrated in FIG. 9 as long as a pixel signal can be generated by photoelectric conversion.

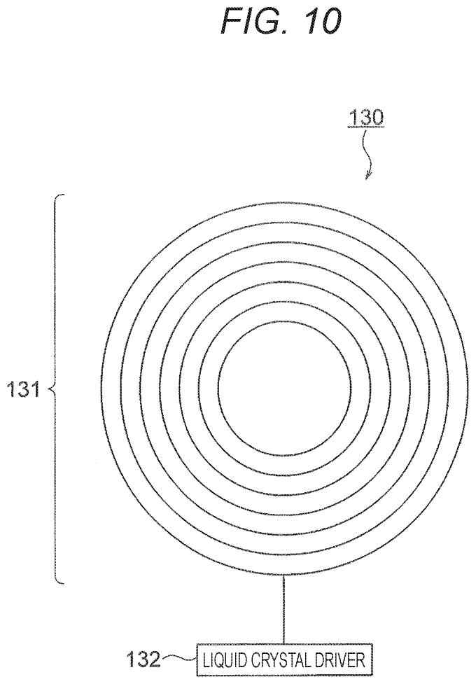

FIG. 10 is a view illustrating an example of a configuration of the liquid crystal optical aperture 130. The liquid crystal optical aperture 130 illustrated in FIG. 10 includes a circular liquid crystal panel 131 and a liquid crystal driver 132. The liquid crystal panel 131 is divided into a plurality of concentric regions. The liquid crystal driver 132 independently controls each of the regions of the liquid crystal panel 131 in accordance with an aperture control signal 405 from the control section 202 of the information processing device 200.

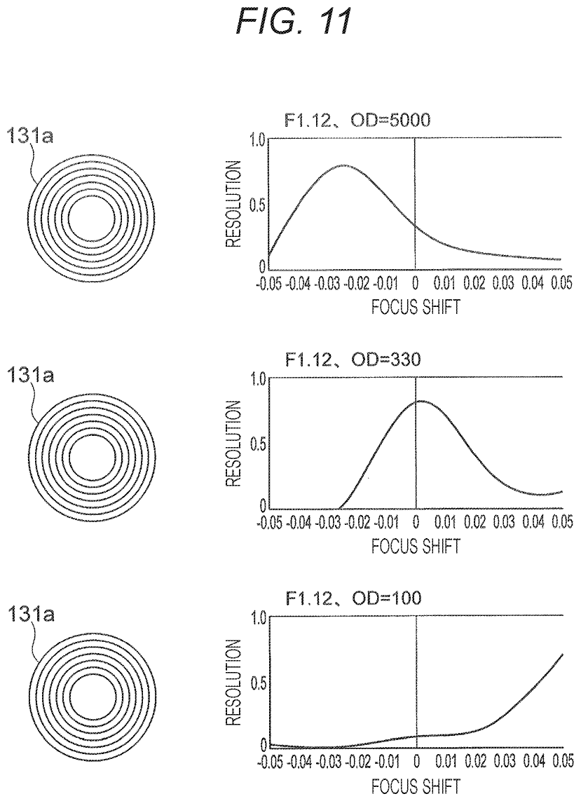

FIG. 11 is a view illustrating optical characteristic graphs of the imaging device 100 when an aperture pattern of the liquid crystal optical aperture 130 illustrated in FIG. 10 has not changed. In the optical characteristic graphs illustrated in FIG. 11, the horizontal axis represents a focus shift of the lens 121a, and the vertical axis represents resolution of the imaging device 100. This resolution is an optical characteristic correlated with a contrast value of a distance measurement image of the imaging device 100, and can be calculated, for example, as the image signal processing section 201 performs Fourier transform on a light amount distribution based on a signal 40 generated by the imaging circuit 122.

In FIG. 11, the entire region of the liquid crystal panel 131 is set as a light-transmitting region 131a regardless of the distance OD. In this case, referring to the optical characteristic graphs, a resolution range (a width of the focus shift) decreases, and the resolution decreases as the distance OD from the imaging device 100 to the subject 300 decreases.

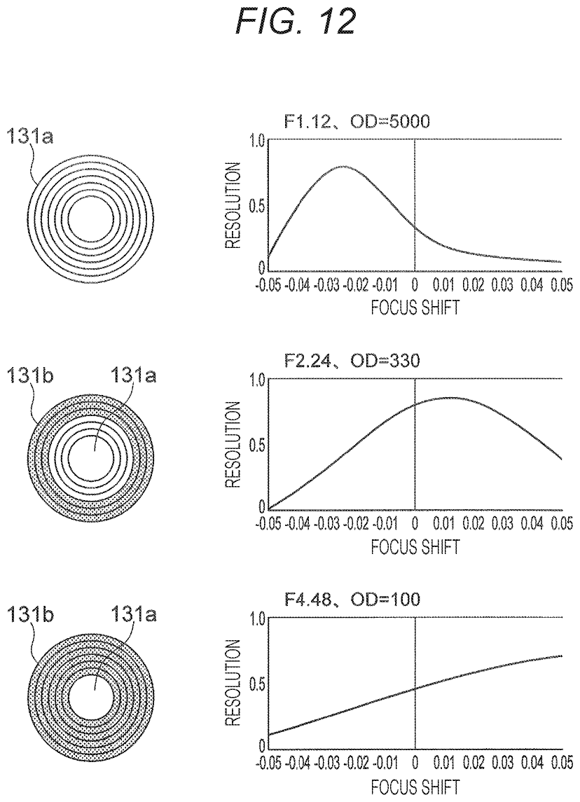

FIG. 12 is a view illustrating optical characteristic graphs of the imaging device 100 when an aperture pattern of the liquid crystal optical aperture 130 illustrated in FIG. 10 has changed.

In the liquid crystal panel 131 illustrated in FIG. 12, the light-transmitting region 131a that transmits the reflection light 302 and a light-shielding region 131b that shields the reflection light 302 change concentrically depending on the distance OD. In this liquid crystal panel 131, the control section 202 sets an aperture value F to be larger as the distance OD becomes shorter. As the aperture value F increases, a transmission light amount of the reflection light 302 in the liquid crystal panel 131 decreases. Therefore, as the distance OD decreases, the light-shielding region 131b gradually increases from the outer side toward the inner side in the radial direction, whereas the light-transmitting region 131a decreases.

In a case where the light-transmitting region 131a and the light-shielding region 131b change depending on the distance OD as described above, a resolution range is wider when the distance OD is a middle distance (330 mm), and the resolution is higher when the distance OD is a short distance (100 mm) as compared with the optical characteristic graphs illustrated in FIG. 11. Note that the aperture pattern of the liquid crystal optical aperture 130 is not limited to the concentric pattern illustrated in FIG. 12.

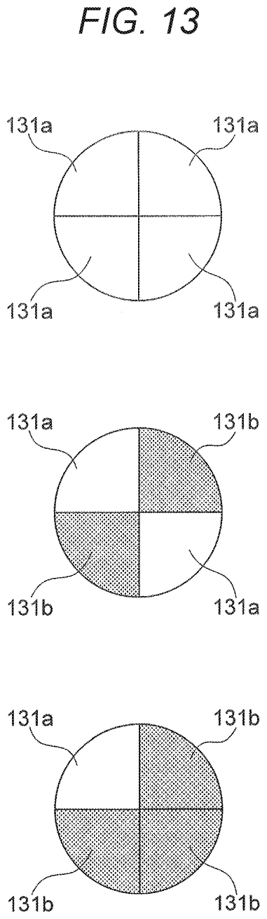

FIG. 13 is a view illustrating another example of the aperture pattern of the liquid crystal optical aperture 130. In FIG. 13, the liquid crystal panel 131 having a circular shape is equally divided into a plurality of fan-shaped regions. Each of the regions is independently set as the light-transmitting region 131a or the light-shielding region 131b by the liquid crystal driver 132. In this liquid crystal panel 131 as well, the control section 202 sets the aperture value F to be larger as the distance OD becomes shorter. As a result, as the distance OD decreases, the light-shielding region 131b increases stepwise in the circumferential direction, whereas the light-transmitting region 131a decreases.

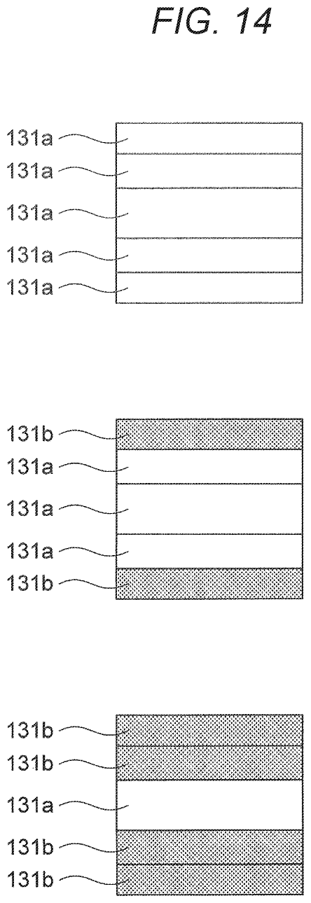

FIG. 14 is a view illustrating still another example of the aperture pattern of the liquid crystal optical aperture 130. In FIG. 14, the liquid crystal panel 131 having a rectangular shape is divided into a plurality of striped regions. Each of the regions is independently set as the light-transmitting region 131a or the light-shielding region 131b by the liquid crystal driver 132. In this liquid crystal panel 131 as well, the control section 202 sets the aperture value F to be larger as the distance OD becomes shorter. As a result, as the distance OD decreases, the light-shielding region 131b increases stepwise in a side direction, whereas the light-transmitting region 131a decreases.

The storage section 424 can be formed with a storage medium such as a read only memory (ROM). The storage section 424 stores various data values.

Next, an operation of the above-described imaging system 1 will be described. Here, an operation of adjusting the aperture value F of the liquid crystal optical aperture 130 in accordance with the distance OD from the imaging device 100 to the subject 300 will be described.

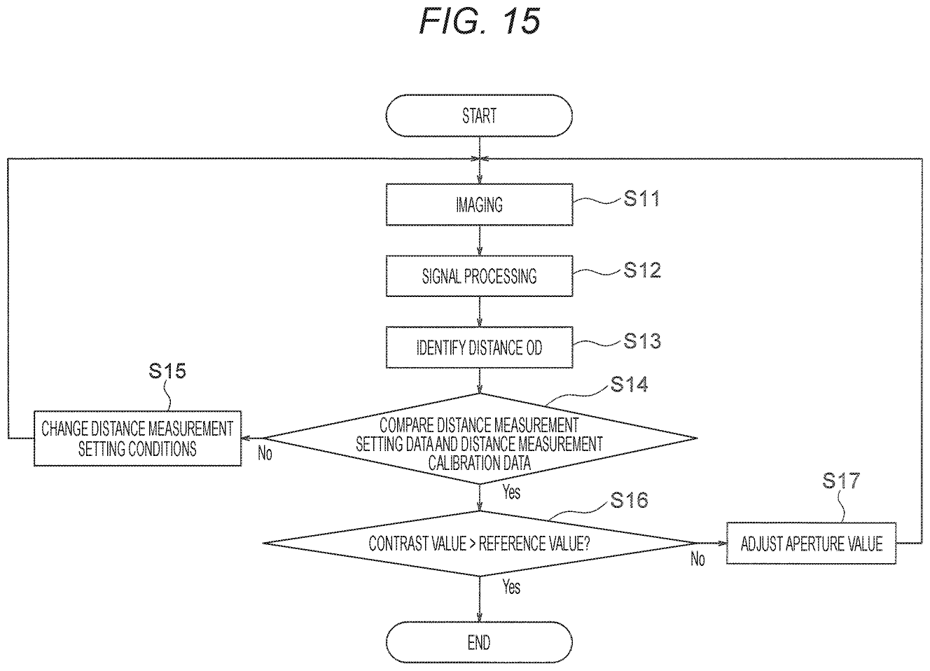

FIG. 15 is a flowchart illustrating a procedure of the operation of adjusting the aperture value F of the liquid crystal optical aperture 130.

When the imaging system 1 is activated, first, the imaging device 100 images the subject 300 on the basis of control of the control section 202 (step S11). In step S11, the emission optical system 110 irradiates the subject 300 with the emission light 301. Subsequently, the imaging section 120 photoelectrically converts the reflection light 302 transmitted through the liquid crystal optical aperture 130. Moreover, the imaging section 120 generates a plurality of the pixel signals 400 by the photoelectric conversion of the reflection light 302.

Next, the image signal processing section 201 processes the pixel signals 400 to generate a distance measurement image (step S12). Subsequently, the image signal processing section 201 identifies the distance OD from the imaging device 100 to the subject 300 on the basis of the distance measurement image (step S13). Subsequently, the image signal processing section 201 compares distance measurement setting data of the imaging device 100 set at the time of imaging the distance measurement image described above with distance measurement calibration data corresponding to the distance OD identified in step S13 (step S14).

The distance measurement setting data includes, for example, a light emission amount of the emission optical system 110, exposure time of the imaging circuit 122, and the like. The light emission amount of the emission optical system 110 corresponds to, for example, the drive current Id of the light emitting element 111a (see FIG. 2). The drive current Id can be set on the basis of the light emission control signal 403 from the control section 202. Therefore, the image signal processing section 201 can grasp the light emission amount of the emission optical system 110 through the control section 202.

The exposure time of the imaging circuit 122 corresponds to, for example, avalanche multiplication time of the photodiode 1220 (see FIG. 6) or charge accumulation time of the photodiode 1271 (FIG. 9). The avalanche multiplication time is adjusted by the switch 1225, and an operation of the switch 1225 can be controlled on the basis of the exposure control signal 404 from the control section 202. Furthermore, the charge accumulation time is adjusted by the transfer transistors 1272 and 1273, and operations of the transfer transistors 1272 and 1273 can be controlled on the basis of the exposure control signal 404 from the control section 202. Therefore, the image signal processing section 201 can also grasp the exposure time of the imaging circuit 122 through the control section 202.

Meanwhile, the distance measurement calibration data is stored in the storage section 140. The distance measurement calibration data indicates optimum values of characteristics that affect distance measurement performance, such as the light emission amount of the emission optical system 110 and the exposure time of the imaging circuit 122, for each of a plurality of the distances OD such as a long distance OD (5000 mm), a medium distance OD (330 mm), and a short distance OD (100 mm), for example.

When the image signal processing section 201 notifies the control section 202 of a result that a difference between the distance measurement setting data and the distance measurement calibration data is out of an allowable range, the control section 202 changes distance measurement setting conditions of the imaging device 100, that is, the light emission amount of the emission optical system 110 and the exposure time of the imaging circuit 122, to the optimum values indicated in the distance measurement calibration data (step S15). Thereafter, the imaging device 100 images the subject 300 under the changed distance measurement setting conditions, and the image signal processing section 201 outputs the image signal 401 to the control section 202.

Next, the image signal processing section 201 compares a contrast value of the distance measurement image with a reference value (step S16). The reference value is set in advance for every distance OD and stored in the storage section 140.

When the image signal processing section 201 notifies the control section 202 of a result that the contrast value is less than the reference value, the control section 202 adjusts the aperture value F of the liquid crystal optical aperture 130 (step S17). In step S17, the control section 202 may use data obtained by optimizing the aperture value F for every distance OD stored in the storage section 140, or may change the aperture value F stepwise.

Thereafter, the operations of steps S11 to S17 described above are repeated until the contrast value exceeds the reference value.

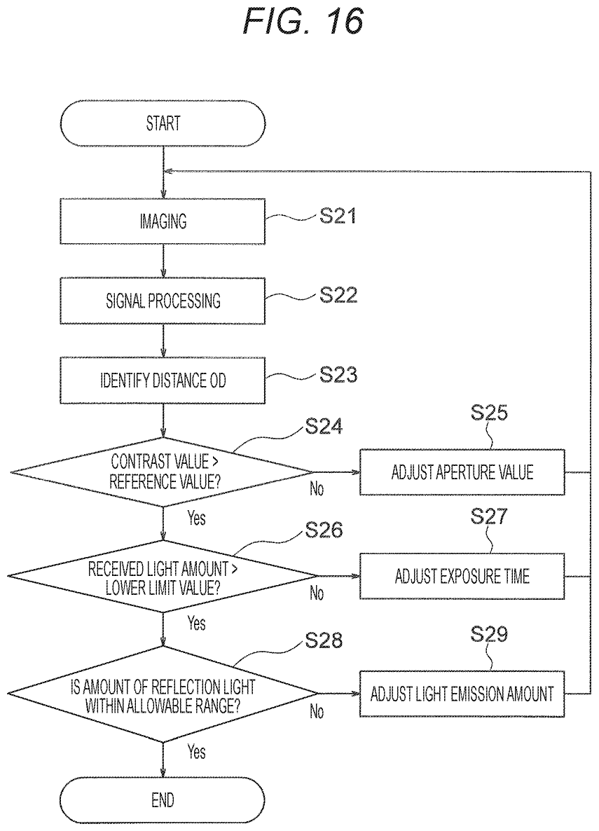

FIG. 16 is a flowchart illustrating another procedure of the operation of adjusting the aperture value F of the liquid crystal optical aperture 130.

When the imaging system 1 is activated, operations similar to those in steps S11 to S13 described above are executed. That is, the imaging device 100 images the subject 300 on the basis of control of the control section 202 (step S21), and subsequently, the image signal processing section 201 processes the pixel signal 400 (step S22) and identifies the distance OD (step S23).

Next, in the flowchart shown in FIG. 16, the image signal processing section 201 compares a contrast value of a distance measurement image with the reference value (step S24). In a case where the contrast value is less than the reference value, the control section 202 adjusts the aperture value F of the liquid crystal optical aperture 130 similarly to step S17 described above (step S25).

When the contrast value exceeds the reference value, the image signal processing section 201 compares a received light amount of the imaging circuit 122 with a lower limit value (step S26). For example, when the distance OD changes, an amount of the reflection light 302 received by the imaging circuit 122 also changes. Therefore, this lower limit value corresponds to the minimum light intensity necessary for the imaging circuit 122 to generate the pixel signal 400, and is stored in the storage section 140.

In a case where the received light amount of the imaging circuit 122 is less than the lower limit value, the control section 202 adjusts exposure time of the imaging circuit 122 through the exposure control signal 404 (step S27). In step S17, the control section 202 may adjust the exposure time on the basis of the above-described distance measurement calibration data, or may adjust the exposure time stepwise.

When the received light amount of the imaging circuit 122 exceeds the lower limit value, the image signal processing section 201 determines whether or not a light amount of the reflection light 302 incident on the liquid crystal optical aperture 130 is within an allowable range (step S28). For example, when a reflectance of the subject 300 with respect to the emission light 301 changes, the light amount of the reflection light 302 also changes. Therefore, this allowable range is set between an upper limit value and the lower limit value of the light incident on the liquid crystal optical aperture 130, and is stored in the storage section 140. Furthermore, the light amount of the reflection light 302 incident on the liquid crystal optical aperture 130 can be measured by, for example, an optical sensor installed on an incident surface side of the liquid crystal optical aperture 130.

In a case where the light amount of the reflection light 302 is out of the allowable range, the control section 202 adjusts a light emission amount of the emission optical system 110 through the light emission control signal 402 (step S29). In step S29, the control section 202 outputs the light emission control signal 402 for decreasing the light emission amount and the light emission control signal 402 for increasing the light emission amount when the light amount of the reflection light 302 exceeds the upper limit value and falls below the lower limit value, respectively.

According to the present embodiment described above, the aperture value F of the liquid crystal optical aperture 130 is set in accordance with the distance OD to the subject. Therefore, the received light amount of the imaging section 120 is optimized even when the distance OD changes. Therefore, it is possible to reduce a difference in the resolution of the distance measurement image caused by a difference in the distance OD.

### Second Embodiment

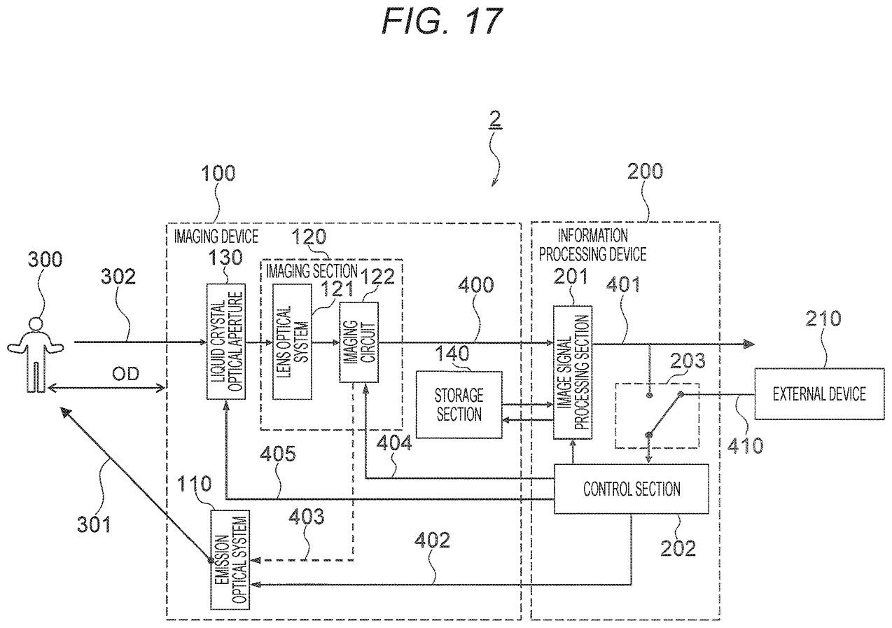

FIG. 17 is a block diagram illustrating a configuration example of an imaging system according to a second embodiment. Components similar to those of the first embodiment described above will be denoted by the same reference signs, and detailed description thereof will be omitted.

In an imaging system 2 according to the present embodiment, the imaging device 100 has a configuration similar to that of the first embodiment, and the information processing device 200 further includes a switch 203 in addition to the image signal processing section 201 and the control section 202.

The switch 203 switches a connection destination of the control section 202 between the image signal processing section 201 and an external device 210. The external device 210 is imaging equipment having a distance measurement function, such as a red (R)-green (G)-blue (B) camera. When the control section 202 and the external device 210 are connected, an external signal 410 is input from the external device 210 to the control section 202. The external signal 410 is an image signal obtained by the external device 210 imaging the subject 300 at the same distance as the distance OD in advance. Therefore, the external signal 410 includes information about the distance OD.

In the present embodiment, the control section 202 adjusts the aperture value F of the liquid crystal optical aperture 130 on the basis of the distance OD indicated by the external signal 410.

According to the present embodiment described above, the information about the distance OD can be acquired even if the imaging device 100 does not measure the distance OD to the subject 300. Therefore, when the aperture value F of the liquid crystal optical aperture 130 is adjusted, a distance measurement operation of the imaging device 100, that is, a light emission operation of the emission optical system 110 and a photoelectric conversion operation of the imaging circuit 122 become unnecessary. Therefore, it is possible to shorten time for adjustment of the aperture value F of the liquid crystal optical aperture 130.

### Application Example to Moving Body

The technology according to the present disclosure (the present technology) can be applied to various products. For example, the technology according to the present disclosure may also be achieved as a device mounted on any type of mobile body such as an automobile, an electric vehicle, a hybrid electric vehicle, a motorcycle, a bicycle, a personal mobility, an airplane, a drone, a boat, a robot, and the like.

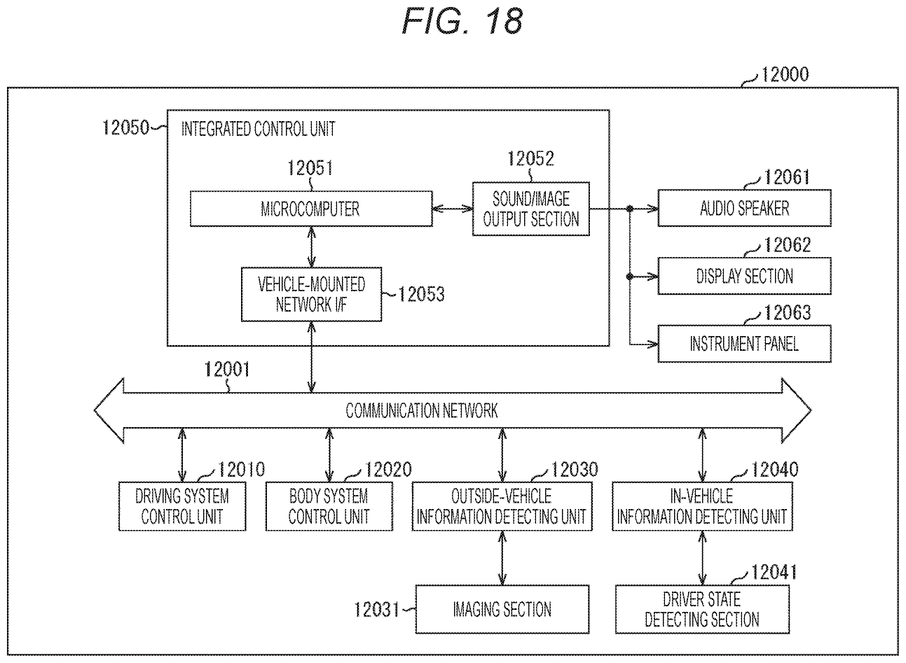

FIG. 18 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 18, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as functional configurations of the integrated control unit 12050.

The driving system control unit 12010 controls the operation of devices related to the driving system of the vehicle in accordance with various kinds of programs. For example, the driving system control unit 12010 functions as a control device for a driving force generating device for generating a driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or auditorily notifying an occupant of the vehicle or the outside of the vehicle of information. In the example of FIG. 18, an audio speaker 12061, a display section 12062, and an instrument panel 12063 are illustrated as the output device. The display section 12062 may, for example, include at least one of an on-board display or a head-up display.

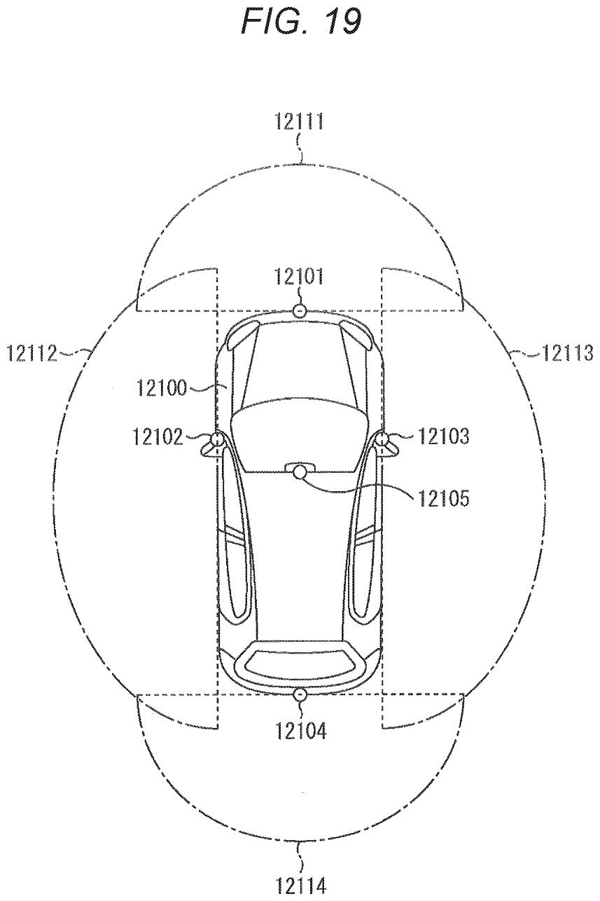

FIG. 19 is a view illustrating an example of an installation position of the imaging section 12031.

In FIG. 19, the imaging section 12031 includes imaging sections 12101, 12102, 12103, 12104, and 12105.

The imaging sections 12101, 12102, 12103, 12104, and 12105 are, for example, provided at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 19 depicts an example of image capturing ranges of the imaging sections 12101 to 12104. An imaging range 12111 represents the imaging range of the imaging section 12101 provided to the front nose. Imaging ranges 12112 12113 respectively represent the imaging ranges of the imaging sections 12102 and 12103 provided on the sideview mirrors. An imaging range 12114 represents the imaging range of the imaging section 12104 provided on the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure may be applied has been described above. The technology according to the present disclosure can be applied to, for example, the imaging section 12031 and the like in the configuration described above. Specifically, the imaging device 100 can be applied to the imaging section 12031. When the technology according to the present disclosure is applied, imaged images having a smaller difference in resolution can be obtained, so that safety can be improved.

Note that the present technology can have the following configurations.
(1) An imaging device including:

an imaging section that photoelectrically converts reflection light reflected by a subject; and

a liquid crystal optical aperture that is arranged on a side closer to the subject than the imaging section and has an aperture value that is variable depending on a distance to the subject and indicates a transmission light amount of the reflection light.
(2) The imaging device according to (1), further including an emission optical system that irradiates the subject with infrared light.
(3) The imaging device according to (1) or (2), in which the aperture value is variable on the basis of a contrast value of a distance measurement image generated on the basis of the photoelectric conversion of the imaging section.
(4) The imaging device according to (2), in which a light amount of the infrared light is variable depending on a light amount of the reflection light incident on the liquid crystal optical aperture.
(5) The imaging device according to (4), in which exposure time of the imaging section is variable depending on a light amount of the reflection light received by the imaging section.
(6) The imaging device according to any one of (1) to (5), in which the aperture value is variable on the basis of the distance measured in advance outside the imaging device.
(7) The imaging device according to any one of (1) to (6), in which the aperture value is variable on the basis of data optimized for every value of the distance.
(8) The imaging device according to (7), further including a storage section that stores the data.
(9) The imaging device according to any one of (1) to (8), in which a light-transmitting region and a light-shielding region change depending on the aperture value of the liquid crystal optical aperture.
(10) The imaging device according to (9), in which the liquid crystal optical aperture has a circular shape, and the light-transmitting region and the light-shielding region change concentrically depending on the aperture value.
(11) The imaging device according to (9), in which the liquid crystal optical aperture has a circular shape, and the light-transmitting region and the light-shielding region change in fan shapes depending on the aperture value.
(12) The imaging device according to (9), in which the liquid crystal optical aperture has a rectangular shape, and the light-transmitting region and the light-shielding region change in a side direction depending on the aperture value.
(13) An imaging system including:

an imaging section that photoelectrically converts reflection light reflected by a subject;

a liquid crystal optical aperture that is arranged on a side closer to the subject than the imaging section and has an aperture value that is variable depending on a distance to the subject and indicates a transmission light amount of the reflection light;

an image signal processing section that processes a signal generated from the photoelectric conversion of the imaging section; and

a control section that adjusts the aperture value on the basis of a processing result of the image signal processing section.
(14) The imaging system according to (13), further including a switch that switches a connection destination of the control section between the image signal processing section and an external device that images the subject at the distance in advance.
(15) The imaging system according to (13) or (14), in which the aperture value is variable on the basis of a contrast value of a distance measurement image generated on the basis of the photoelectric conversion of the imaging section.
(16) The imaging system according to any of (13) to (15), in which the aperture value is variable on the basis of data optimized for every value of the distance.
(17) The imaging system according to any one of (13) to (16), in which a light-transmitting region and a light-shielding region change depending on the aperture value of the liquid crystal optical aperture.
(18) The imaging system according to (17), in which the liquid crystal optical aperture has a circular shape, and the light-transmitting region and the light-shielding region change concentrically depending on the aperture value.
(19) The imaging system according to (17), in which the liquid crystal optical aperture has a circular shape, and the light-transmitting region and the light-shielding region change in fan shapes depending on the aperture value.
(20) The imaging system according to (17), in which the liquid crystal optical aperture has a rectangular shape, and the light-transmitting region and the light-shielding region change in a side direction depending on the aperture value.

### REFERENCE SIGNS LIST

1, 2 Imaging system
110 Emission optical system
120 Imaging section
130 Liquid crystal optical aperture
131a Light-transmitting region
131b Light-shielding region
140 Storage section
201 Image signal processing section
202 Control section
203 Switch
301 Emission light
302 Reflection light

1. An imaging device comprising:
an imaging section that photoelectrically converts reflection light reflected by a subject; and
a liquid crystal optical aperture that is arranged on a side closer to the subject than the imaging section and has an aperture value that is variable depending on a distance to the subject and indicates a transmission light amount of the reflection light.

2. The imaging device according to claim 1, further comprising an emission optical system that irradiates the subject with infrared light.

3. The imaging device according to claim 1, wherein the aperture value is variable on a basis of a contrast value of a distance measurement image generated on a basis of the photoelectric conversion of the imaging section.

4. The imaging device according to claim 2, wherein a light amount of the infrared light is variable depending on a light amount of the reflection light incident on the liquid crystal optical aperture.

5. The imaging device according to claim 4, wherein exposure time of the imaging section is variable depending on a light amount of the reflection light received by the imaging section.

6. The imaging device according to claim 1, wherein the aperture value is variable on a basis of the distance measured in advance outside the imaging device.

7. The imaging device according to claim 1, wherein the aperture value is variable on a basis of data optimized for every value of the distance.

8. The imaging device according to claim 7, further comprising a storage section that stores the data.

9. The imaging device according to claim 1, wherein a light-transmitting region and a light-shielding region change depending on the aperture value of the liquid crystal optical aperture.

10. The imaging device according to claim 9, wherein the liquid crystal optical aperture has a circular shape, and the light-transmitting region and the light-shielding region change concentrically depending on the aperture value.

11. The imaging device according to claim 9, wherein the liquid crystal optical aperture has a circular shape, and the light-transmitting region and the light-shielding region change in fan shapes depending on the aperture value.

12. The imaging device according to claim 9, wherein the liquid crystal optical aperture has a rectangular shape, and the light-transmitting region and the light-shielding region change in a side direction depending on the aperture value.

13. An imaging system comprising:
an imaging section that photoelectrically converts reflection light reflected by a subject;
a liquid crystal optical aperture that is arranged on a side closer to the subject than the imaging section and has an aperture value that is variable depending on a distance to the subject and indicates a transmission light amount of the reflection light;
an image signal processing section that processes a signal generated from the photoelectric conversion of the imaging section; and
a control section that adjusts the aperture value on a basis of a processing result of the image signal processing section.

14. The imaging system according to claim 13, further comprising a switch that switches a connection destination of the control section between the image signal processing section and an external device that images the subject at the distance in advance.

15. The imaging system according to claim 13, wherein the aperture value is variable on a basis of a contrast value of a distance measurement image generated on a basis of the photoelectric conversion of the imaging section.

16. The imaging system according to claim 13, wherein the aperture value is variable on a basis of data optimized for every value of the distance.

17. The imaging system according to claim 13, wherein a light-transmitting region and a light-shielding region change depending on the aperture value of the liquid crystal optical aperture.

18. The imaging system according to claim 17, wherein the liquid crystal optical aperture has a circular shape, and the light-transmitting region and the light-shielding region change concentrically depending on the aperture value.

19. The imaging system according to claim 17, wherein the liquid crystal optical aperture has a circular shape, and the light-transmitting region and the light-shielding region change in fan shapes depending on the aperture value.

20. The imaging system according to claim 17, wherein the liquid crystal optical aperture has a rectangular shape, and the light-transmitting region and the light-shielding region change in a side direction depending on the aperture value.
